(19) United States
(12) Patent Application Publication
(10) Pub. No.: US 2019/0392479 A1
(43) Pub. Date: Dec. 26, 2019

(54) METHOD FOR DISCOVERING SALES EVENTS

(71) Applicant: Yardaroo, LLC, Lockport, NY (US)

(72) Inventor: Andrew R. Mitchell, Lockport, NY (US)

(21) Appl. No.: 16/442,715

(22) Filed: Jun. 17, 2019

Related U.S. Application Data
(60) Provisional application No. 62/688,095, filed on Jun. 21, 2018.

(51) Int. Cl. G06Q 30/02

(52) U.S. Cl. CPC G06Q 30/0252; G06Q 30/0272; G06Q 30/0276; G06Q 30/0259

(57) ABSTRACT

A method for discovering sales events, comprising receiving an event from a seller, receiving a first set of information from the seller, storing the first set of information in a database, placing a limit on the event, receiving an activation request from the seller, and activating the event. The method may further include receiving a request from a buyer, receiving a second set of information from the buyer, generating a list of one or more events based on the second set of information, receiving a selection from a buyer, wherein the selection includes at least one of the one or more events, and generating an optimized route to each of the at least one of the one or more events.

### CROSS-REFERENCE TO RELATED APPLICATIONS

This application claims the benefit under 35 U.S.C. § 119(e) of U.S. Provisional Application No. 62/688,095, filed Jun. 21, 2018, which application is incorporated herein by reference in its entirety.

### FIELD

The present disclosure relates to sales events, and, more particularly, to a method of finding sales events based on user criteria, and even more particularly, to optimizing a route to sales events based on a user selection of the found sales events.

### REFERENCE TO COMPUTER PROGRAM LISTING APPENDIX

The present application includes a computer program listing appendix. The appendix contains an ASCII text listing of the computer program or sample file input data as follows:

| | | |
|---|---|---|
| Program_Code.txt | 1,704 KB | Created 06/16/2018 |

### BACKGROUND

A garage sale, also known as a yard sale, tag sale, moving sale, and by many other names, is an informal event for the sale of used goods by private individuals, in which sellers are not required to obtain business licenses or collect sales tax (though, in some jurisdictions, a permit may be required). Typically the goods in a garage sale are unwanted items from the household with its owners conducting the sale. The conditions of the goods vary, but they are usually usable. Some of these items are offered for sale because the owner does not want or need the item, to minimize their possessions, or to raise funds. Popular motivations for a garage sale are for “spring cleaning,” moving, or earning extra money. Items typically sold at garage sales include old clothing, books, toys, household decorations, lawn and garden tools, sports equipment, and board games. Larger items like furniture and occasionally home appliances are also sold. Garage sales occur most frequently in suburban areas on weekends with good weather conditions, and usually have designated hours for the sale. Buyers who arrive before the hours of the sale to review the items are known as “early birds” and are often professional restorers or resellers. Such sales also attract people who are searching for bargains or for rare and unusual items. Bargaining, also known as haggling, on prices is routine, and items may or may not have price labels affixed. Some people buy goods from these sales to restore them for resale.

The seller's items are displayed to the passers-by or those responding to signs, flyers, classified advertisements, or newspaper advertisements. In some cases, local television stations will broadcast a sale on a local public channel. The venue at which the sale is conducted is typically a garage; other sales are conducted at a driveway, carport, front yard, or inside a house. Some vendors, known as “squatters,” will set up in a high-traffic area rather than on their own property. However, finding these private individual sales can be difficult.

Thus, there is a long-felt need for a method for sellers to advertise their private sale on an inexpensive largescale platform, and for buyers to find these private sales events.

### SUMMARY

According to aspects illustrated herein, there is provided a method for discovering sales events, comprising receiving, by one or more computer processors, an event from a seller, receiving, by the one or more computer processors, a first set of information from the seller, storing, by the one or more computer processors, the first set of information in a database, placing, by the one or more computer processors, a limit on the event, receiving, by the one or more computer processors, an activation request from the seller, and activating, by the one or more computer processors, the event.

According to aspects illustrated herein, there is provided a computer program product for discovering sales events, comprising a computer readable storage medium and program instructions stored on the computer readable storage medium, the program instructions comprising program instructions to receive an event from a seller, program instructions to receive a first set of information from the seller, program instructions to store the first set of information in a database, program instructions to place a limit on the event, program instructions to receive an activation request from the seller, and program instructions to activate the event.

According to aspects illustrated herein, there is provided a computer system for discovering sales events, comprising one or more computer processors, one or more computer readable storage media, and program instructions stored on the computer readable storage media for execution by at least one of the one or more computer processors, the program instructions comprising program instructions to receive an event from a seller, program instructions to receive a first set of information from the seller, program instructions to store the first set of information in a database, program instructions to place a limit on the event, program instructions to receive an activation request from the seller, and program instructions to activate the event.

According to aspects illustrated herein, there is provided a method for discovering sales events, comprising receiving, by one or more computer processors, an event from a seller, receiving, by the one or more computer processors, a first set of information from the seller, storing, by the one or more computer processors, the first set of information in a database, placing, by the one or more computer processors, a limit on the event, receiving, by the one or more computer processors, an activation request from the seller, activating, by the one or more computer processors, the event, receiving, by the one or more computer processors, a request from a buyer, receiving, by the one or more computer processors, a second set of information from the buyer, generating, by the one or more computer processors, a list of one or more events based on the second set of information, receiving, by the one or more computer processors, a selection from a buyer, wherein the selection includes at least one of the one or more events, and generating, by the one or more computer processors, an optimized route to each of the at least one of the one or more events.

According to aspects illustrated herein, there is provided a computer-processor-based system capable of configuring, hosting, and presenting transient, physical location-based sale events to a given end user in a variety of display views including lists, maps, and directions. Sale events are allowed to be configured to operate for a finite amount of time, making the system fair and accessible to the broadest range of end users. The system promotes local tourism, commerce, and patronage to local restaurants and businesses via sophisticated search algorithms and simple workflow-based user interactions. Due to the nature of the system it does not require extraneous data to be collected, making it resilient and less prone to data breaches and abuse. The system is architected and designed in such a way that it can scale internationally and can thus be deployed in other countries in accordance to their respective laws and regulations.

According to some embodiments, a user of the system can create an account to manage notification settings, sale events, and/or campaigns, depending on the type of account created. There are three types of users of the system: 1) a default user/visitor, who can set preferences and notification settings; 2) a sale event manager, who can create, edit, activate/deactivate/delete sale events, and set preferences and notification settings; and, 3) partner/advertiser, who can create, edit, activate/deactivate/delete, fund campaigns, view advertisement campaign performance via a dashboard, and set preferences and notification settings. To create an account, a user must provide valid/verifiable digital contact data and a password. The new user will then receive a digital notification using their provided digital contact data containing a web link appended with a unique identifier. Following this link in a web browser will verify and activate their user account.

A Sale Event Manager is granted system privileges to create, edit, activate/deactivate/delete sale events. When a sale event is created, a seller also submits a set of information related to the sale event. Sale event information may comprise of a date range (start date and end date). A sale event may be limited in time (e.g., to a maximum duration of 3 days) and can be set up to occur/start in the future (e.g., created up to 30 days in the future). Sale event information may comprise of a time range (start time and end time). The time range indicates to users what time sale events can be expected to be occurring. Sale event information may comprise of a genre, which represents the type of event a user can expect. The sale event genre may include, but is not limited to, yard sales, barn sales, estate sales, dorm sales, garage sales, block sales, etc. In some embodiments, a sale event can only be categorized in one genre. Sale event information may comprise of a location (i.e., the physical address of the sale event). The sale event location is verified, geocoded, and saved on one or more servers. Sale event information may comprise a description, or long form arbitrary text used to describe a sale event. Sale event information may comprise one or more tags, or short groups of word(s) used to describe items sold at a sale event. In some embodiments, a sale event can be activated/deactivated at any time for any reason by the sale event manager user. In some embodiments, a sale event can be deleted by the sale event manager user at any time for any reason. In some embodiments, a sale event manager user may only have one active sale event at a time.

A partner/advertiser is granted system privileges to create, edit, activate/deactivate/delete, and fund advertisement campaigns. A partner/advertiser must complete either an automated of manual verification process. An example automated verification process might be the use of third party application programming interfaces (APIs) to verify a business. An example manual verification might be via email, phone, or other mode of communication. When an advertisement campaign is created, a partner/advertiser also submits a set of information related to the advertisement campaign. Advertisement campaign information may comprise a date range (start date and end date). An advertisement campaign may be limited in time (e.g., to a maximum duration of 30 days) and can be set up to occur/start in the future (e.g., can be created up to 60 days in the future). Advertisement campaign information may comprise a business genre, which represents the type of business a user can expect when responding to an advertisement campaign. The business genre may include, but is not limited to, restaurants, food stands, farmers markets, auction houses, consignment shops, bakeries, café s, etc. In some embodiments, an advertisement campaign can only be categorized in one business genre. Advertisement campaign information may comprise a location (i.e., the physical address of the business). In some embodiments the location is verified, geocoded, and saved on one or more servers. Advertisement campaign information may comprise a budget (i.e., the total budget for the advertisement campaign). In some embodiments, the partner/advertiser has the option to distribute funds evenly over number of days in campaign. When this option is enabled, the total budget will be spent evenly over the course of the campaign. When this option is disabled, the total budget will be spent as it is used regardless of point in time of campaign. In a first example, the budget is set up to distribute funds evenly over length of campaign, with a total budget of $100 (USD), a length of campaign of 10 days, and a maximum daily spend of $10, which when calculated: $100/10=$10 maximum spend per day. Once the $10 daily max is reached, the advertisement campaign is disabled until the following day. Once the $100 total max budget is spent, the advertisement campaign will be disabled until it is funded again. In a second example, the budget is set up to not distribute funds evenly over length of campaign, with a total budget of $100 (USD), a length of campaign of 10 days, a maximum daily spend of $100, which when calculated: $100=$100 maximum spend per day. Once the total budget of $100 is spent, the advertisement campaign will be disabled until it is funded again, regardless of length of campaign. In some embodiments, a campaign is only initially activated once it is successfully funded. Once activated, a partner/advertiser user can activate/deactivate a campaign for any reason at any time. In some embodiments, a campaign can only be deleted if it does not have any billable activity associated with it. Once billable activity is associated with a campaign, the partner/advertiser user may only activate/deactivate the campaign at any time for any reason. A partner/advertiser user may have multiple campaigns active at any given time. This feature is intended to allow businesses with multiple locations the ability to manage an advertisement campaign per location. However, the number of active advertisement campaigns per physical location is one.

According to some embodiments, a user of the system can set filters, which are a set of information, to search sale events in a given area. Such filters include but are not limited to postal code, sale event date/sale event date range, origin location/physical, sale event genres of interest, tags, and options to include partner/advertiser campaigns. All sale event and advertisement campaign objects must be set to active and not deleted to be included in a given set of search results. With respect to the postal code filter, a given user will enter a postal code to base their search from. This is the primary search criteria and is required. The postal code drives which sale events are included in a given set of search results as well as which partner/advertiser advertisement campaigns are included in a given set of search results. With respect to the sale event date/sale event date range filter, a given user will enter a date or date range to narrow their search results. This is the secondary search criteria and is required. The date/date range filter drives which sale events are included in a given set or search results as well as which partner/advertiser advertisement campaigns are included in a given set of search results. With respect to the origin location filter a given user will enter an origin location to use for distance calculations and routing purposes. The origin location filter is used as default center point when viewing in map mode and in distance calculations. With respect to the sale event genre filter, a given user may provide a selection of sale event genre(s) that they are interested in searching. This criterion is optional and will default to all available sale event genres in the system. The sale event genre filter drives which sale events are included in a given set of search results. With respect to the tags filter, a given user may provide a selection of tags to narrow their search results. The tags filter drives which sale events are included in a given set of search results. Recommended tags are offered to the user based on available tags in the system given previously set search criteria. With respect to the options to include partner/advertiser advertisement campaigns filter, a given user may utilize the option to include partner/advertiser advertisement campaigns in their search results. This options filter drives whether to include partner/advertiser advertisement campaigns in a given set of search results. In some embodiments, options are presented based on business types (e.g., restaurants, food stands, etc.). In some embodiments, options are used in conjunction with date/date range and postal code to narrow search results.

According to some embodiments, given a set of filter criteria, a user may be presented with search results containing any combination of sale events and partner/advertiser advertisement campaigns. Search results contain data relevant to the display of things such as list items in list view, map markers in map view, and detail views. This search result data includes, but is not limited to, geospatial coordinates, formatted address, dates, times, description, and tags. In the case of partner/advertiser campaigns, search result data may include phone number, hours of operation, and customer rating. In list view, a running list of sale event and/or partner/advertiser advertisement campaign locations that have been added to a route are displayed. Once a route is optimized, the displayed list of locations is re-ordered based on each point's placement in the sorted list of waypoints returned from the route optimization service. Generally, list locations are added to a route and the list orders locations based on route optimization. Locations can be added and removed from the list and re-optimized at any time for any reason. In map view, all sale event and partner/advertiser advertisement campaign locations are presented as markers on a given map. Each marker is interactive and can display actions to add a location to/remove a location from list view and to view details of a selected sale event or partner/advertiser advertisement campaign. In some embodiments, scrolling through different locations on the map dynamically alters filter criteria and, instead of searching by postal code, bases search on map bounds (upper northeast and lower southwest). This allows search results to dynamically update based on a user's current position on the map without interacting with a form or manually resubmitting a search. There may also be technological advancements in future iterations that could utilize emerging technologies such as virtual reality, augmented reality, and sensory inputs (speech, retinal, etc.) that could be used to enhance the map view experience. These implications are to be determined, but the system is architected is such a way that future technologies could be implemented at any time for any reason. Regarding detail view, a user may choose to view details about a given sale event or partner/advertiser advertisement campaign. The detail view simply displays any relevant information about a given sale event or partner/advertiser advertisement campaign. This could include dates, times, pictures, descriptions, tags, and any other data associated with the sale event or partner/advertiser advertisement campaign.

According to some embodiments, a user can choose to get and view directions to sale event and/or partner/advertiser advertisement campaign locations via route optimization and traverse route leg. With respect to route optimization, once a user has selected a group of locations, the user may choose to optimize a route based on the given group of locations. This will provide the user with step-by-step directions from location to location (waypoint to waypoint), starting and ending at their origin location. In some embodiments, locations are reordered based on position in list of sorted waypoints. The locations can be displayed as a visualization of a route on map with waypoint markers. With respect to traverse route leg, route optimization results contain data points called route legs. Each route leg represents a group of instructions from one location to the next. Route leg data may include, but is not limited to, step-by-step directions, distance calculations, and time calculations. Traverse route legs allow the user to view directions from location to location. Within each route leg are traverse route leg steps. In some embodiments, the current route leg and/or the current step in the current route leg can be highlighted for easier visualization.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a functional block diagram illustrating an environment;

FIG. 2 is a flowchart depicting operational steps for creating an event based on seller information;

FIG. 3 is a flowchart depicting operational steps for creating an event and generating an optimized route based on seller and buyer information; and,

FIG. 4 is a block diagram of internal and external components of a computer system.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. The assembly of the present disclosure could be driven by hydraulics, electronics, and/or pneumatics.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

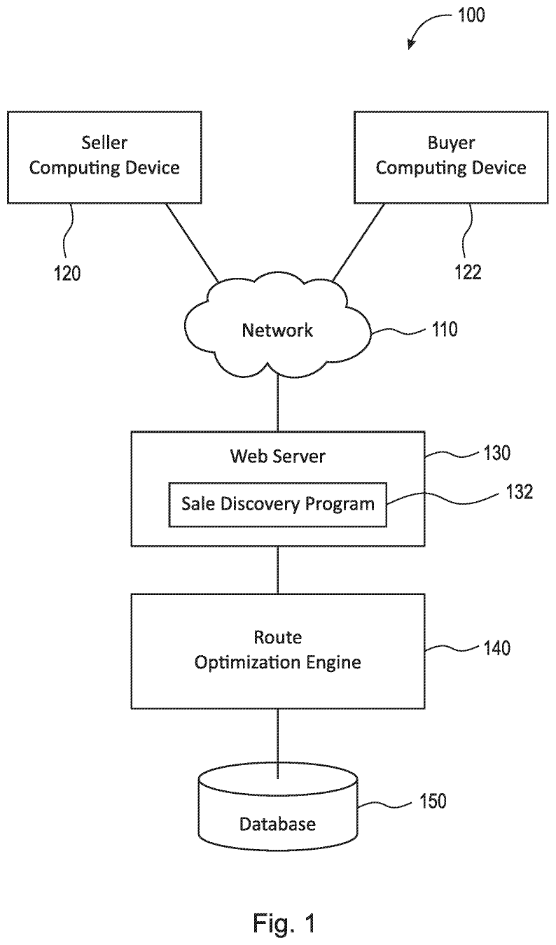

Adverting now to the figures, FIG. 1 is a functional block diagram illustrating a sale creating/discovering environment, generally designated 100. FIG. 1 provides only an illustration of one implementation, and does not imply any limitations with regard to the environments in which different embodiments may be implemented. Many modifications to the depicted environment may be made by those skilled in the art without departing from the scope of the disclosure as recited by the claims. In some embodiments, sale creating/discovering environment 100 includes database 150, route optimization engine 140, seller computing device 120, and buyer computing device 122 connected to web server 130 over network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communication between seller computing device 120 and buyer computing device 122 and web server 130.

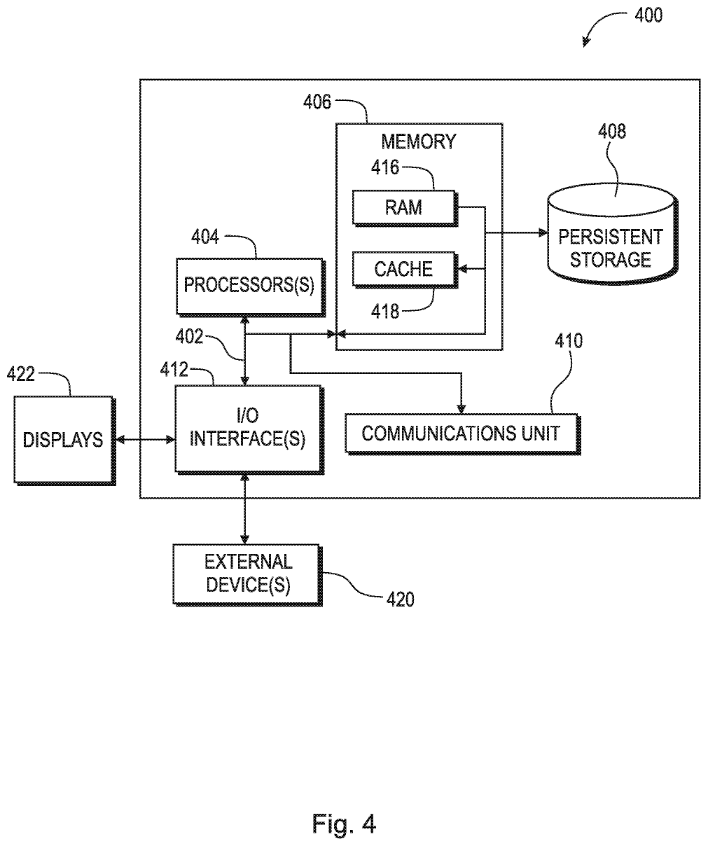

Seller computing device 120 may be a hardware device that allows a seller to create a sales event in sale discovery program 132. In some embodiments, seller computing device 120 is capable of communicating with web server 130 via network 110 to, for example, send data thereto. In some embodiments, seller computing device 120 may include a computer. Seller computing device 120 may include internal and external hardware components, as depicted and described in further detail with respect to FIG. 4. In some embodiments, seller computing device 120 may comprise a computer, a smartphone, an IPAD® tablet computer, a SURFACE® computer, or any other computing device suitable for communicating with network web server 130 via network 110.

Buyer computing device 122 may be a hardware device that allows a buyer to find a sales event in sale discovery program 132. In some embodiments, buyer computing device 122 is capable of communicating with web server 130 via network 110 to, for example, send data thereto and receive data therefrom. In some embodiments, buyer computing device 122 may include a computer. Buyer computing device 122 may include internal and external hardware components, as depicted and described in further detail with respect to FIG. 4. In some embodiments, buyer computing device 120 may comprise a computer, a smartphone, an IPAD® tablet computer, a SURFACE® computer, or any other computing device suitable for communicating with network web server 130 via network 110.

Web server 130 includes sale discovery program 132. Web server 130 may be a management server, a web server, or any other electronic device or computing system capable of receiving and sending data. In some embodiments of the present disclosure, web server 130 can represent a computing system utilizing clustered computers and components to act as a single pool of seamless resources when accessed through a network. In some embodiments, web server 130 is capable of receiving data from seller computing device 120 as well as requests for data from buyer computing device 122, via network 110. Web server 130 may include internal and external hardware components, as depicted and described in further detail with respect to FIG. 4.

Sale discovery program 132 receives requests to create sales events from seller computing device 120 and requests to find sales events from buyer computing device 122. Sale discovery program 132 can receive requests from buyers to find one or more sales events, receive a selection including one or more locations, and provide an optimized route to the one or more locations. Sale discovery program 132 can generally include any software capable of creating and storing sales events based on information from the seller, creating a unit limit on the sales events, finding stored sales events based on information from the buyer and generating a list of events, and communicating with route optimization engine 140 to generate an optimized route based on selected events from the buyer.

Database 150 is a central storage for a set of user and advertiser. Database 150 can be implemented using any non-volatile storage medium known in the art. For example, authentication database can be implemented with a tape library, optical library, one or more independent hard disk drives, or multiple hard disk drives in a redundant array of independent disks (RAID). In some embodiments, database 150 contains the sales events and event information of the one or more sellers as well as information such as filters from the one or more buyers. Additionally database 150 can store partner/advertiser information.

Route optimization engine 140 is a processor that accesses, processes, and presents the data stored by database 150 and/or other data sources. Route optimization engine 140 has the ability to generate an optimized route of events selected by a user. For example, when a buyer is presented with a list of events and the buyer selects one or more of those events, route optimization management engine 140 generates a route to each of the one or more events. The route can be determined for a given user based on predetermined criteria, preferences, user specific information, current location, selection order, or other external sources such as traffic.

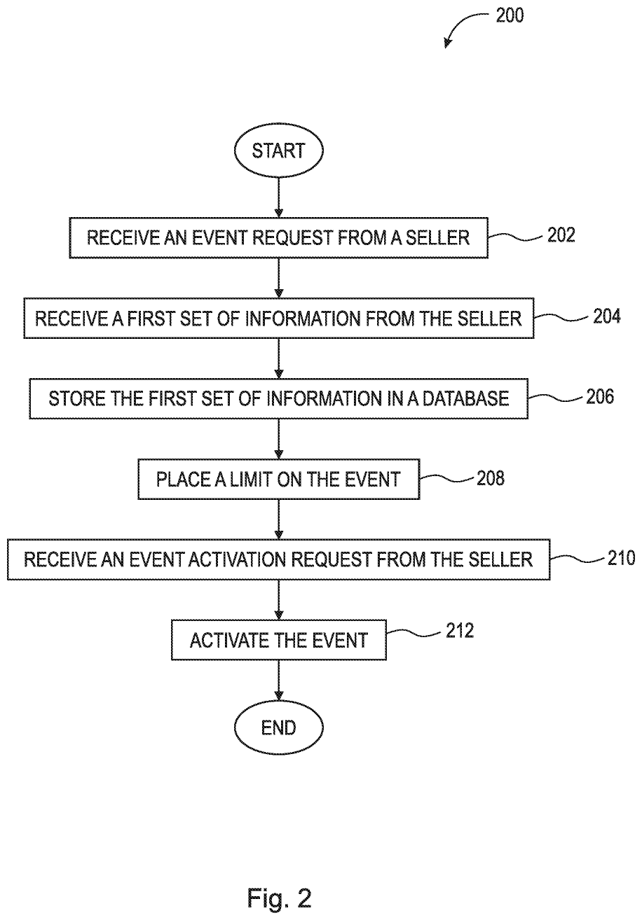

FIG. 2 is a flowchart 200, depicting operational steps for creating an event based on seller information. It should be appreciated that the same flowchart can be used for creating an advertisement campaign based on partner/advertiser information. As such, for the purposes of this disclosure, seller is synonymous with partner/advertiser and event request is synonymous with advertisement campaign request.

In step 202, sale discovery program 132 receives an event request from a seller. In some embodiments, sale discovery program 132 receives the event from seller computing device 120, via network 110, which is a request to set up a new event. For example, this event request may be initiated by a seller entering data into a computing device.

In step 204, sale discovery program 132 receives a first set of information from the seller. Specifically, sale discovery program 132 collects seller information related to the event. In some embodiments, and as previously discussed, the first set of information includes, but is not limited to, date range (including start date and end date), time range (including start time and end time), genre, location, description, tags, etc. In some embodiments, seller information may be manually inputted into seller computing device 120. In some embodiments, seller information may be collected by the seller creating a user profile.

In step 206, sale discovery program 132 stores the first set of information in database 150.

In step 208, sale discovery program 132 places a limit on the event. Specifically, sale discovery program 132 places a limit on the time range, date range, the location (i.e., the specific address may only have a certain number of events in a given time period), and/or any other number of relevant variables. The purpose of sale discovery program 132 is to create for the buyers an experience of “non-mainstream” sales events, such as yard sales, estate sales, garage sales, barn sales, dorm sales, road side vegetable stands, etc. In some embodiments, sales events are limited to a maximum of three days and a given location may only have a sale once every 30 days. In some embodiments, sale discovery program 132 allows the seller to create an event start date up to 30 days in the future. In some embodiments, the limit is specific to the type of sale that is occurring. For example, a limit of 7 days and 10 sales may be applied to an estate sale agency.

In step 210, sale discovery program 132 receives an event activation request from the seller. Following the creation of the event and the submission of the first set of information for the event by the seller, sale discovery program 132 requires the seller to activate the event. This is because the seller may create an event weeks before the event is actually set to take place. The activation request from the seller confirms that seller intends to proceed with the event.

In step 212, sale discovery program 132 activates the event. Once sale discovery program 132 activates the event, the event is then published such that it can be found by buyers, as will be discussed in greater detail below.

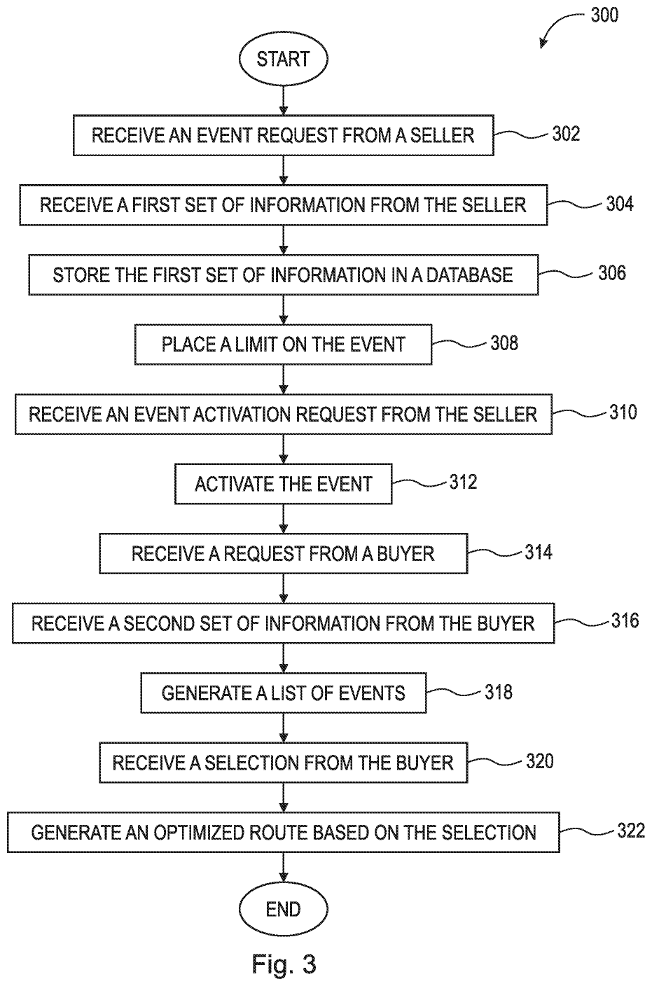

FIG. 3 is a flowchart 300 depicting operational steps for creating an event and generating an optimized route based on seller and buyer information. It should be appreciated that the same flowchart can be used for creating an advertisement campaign based on partner/advertiser information. As such, for the purposes of this disclosure, seller is synonymous with partner/advertiser and event request is synonymous with advertisement campaign request.

In step 302, sale discovery program 132 receives an event request from a seller. In some embodiments, sale discovery program 132 receives the event from seller computing device 120, via network 110, which is a request to set up a new event. For example, this event request may be initiated by a seller entering data into a computing device.

In step 304, sale discovery program 132 receives a first set of information from the seller. Specifically, sale discovery program 132 collects seller information related to the event. In some embodiments, and as previously discussed, the first set of information includes, but is not limited to, date range (including start date and end date), time range (including start time and end time), genre, location, description, tags, etc. In some embodiments, seller information may be manually inputted into seller computing device 120. In some embodiments, seller information may be collected by the seller creating a user profile.

In step 306, sale discovery program 132 stores the first set of information in database 150.

In step 308, sale discovery program 132 places a limit on the event. Specifically, sale discovery program 132 places a limit on the time range, date range, the location (i.e., the specific address may only have a certain number of events in a given time period), and/or any other relevant variable. The purpose of sale discovery program 132 is to create for the buyers an experience of “non-mainstream” sales events, such as yard sales, estate sales, garage sales, barn sales, dorm sales, road side vegetable stands, etc. In some embodiments, sales events are limited to a maximum of three days and a given location may only have a sale once every 30 days. In some embodiments, sale discovery program 132 allows the seller to create an event start date up to 30 days in the future.

In step 310, sale discovery program 132 receives an event activation request from the seller. Following the creation of the event and the submission of the first set of information for the event by the seller, sale discovery program 132 requires the seller to activate the event. This is because the seller may create an event weeks before the event is actually set to take place. The activation request from the seller confirms that seller intends to proceed with the event.

In step 312, sale discovery program 132 activates the event. Once sale discovery program 132 activates the event, the event is then published such that it can be found by buyers, as will be discussed in greater detail below.

In step 314, sale discovery program 132 receives a request from a buyer. In some embodiments, sale discovery program 132 receives the request from buyer computing device 122, via network 110, which is a request to search for one or more events. For example, this request may be initiated by a buyer entering data into a computing device.

In step 316, sale discovery program 132 receives a second set of information from the buyer. Specifically, sale discovery program 132 collects buyer information related to the desired search for events. In some embodiments, and as previously discussed, the second set of information includes, but is not limited to, filters such as postal code, date/date range, origin location, sale event genre, tags, options to include partner/advertiser advertisement campaigns, etc. In some embodiments, buyer information may be manually inputted into buyer computing device 122. In some embodiments, buyer information may be collected by the buyer creating a user profile.

In step 318, sale discovery program 132 generates a list of events based on the second set of data. For example, if the buyer is looking for lawn equipment and fresh vegetables, sale discovery program 132 may generate a list of events which includes one or more yard sales, one or more garage sales, and one or more farmer's markets within the specified geographic location.

In step 320, sale discovery program 132 receives a selection from the buyer. Specifically, in this step the buyer selects from the list of events those events of interest. For example, the buyer may select one garage sale, one yard sale, and two farmer's markets.

In step 322, sale discovery program 132 generates an optimized route based on the selection from the buyer. In this step, sale discovery program 132 may access route optimization engine 150 or use other third party route mapping engines known in the art. For example, sale discovery program 132 may generate the fastest route between the selected one garage sale, one yard sale, and two farmer's markets. In some embodiments, if a hot dog stand is selected, sale discovery program 132 provides a route that places the buyer's time of arrival at the hot dog stand around a certain time, for example, lunch time.

FIG. 4 is a block diagram of internal and external components of computing device 400, which is representative of the computing devices of FIG. 1. It should be appreciated that FIG. 4 provides only an illustration of one implementation and does not imply any limitations with regard to the environments in which different embodiments may be implemented. In general, the components illustrated in FIG. 4 are representative of any electronic device capable of executing machine-readable program instructions. Examples of computer systems, environments, and/or configurations that may be represented by the components illustrated in FIG. 4 include, but are not limited to, personal computer systems, server computer systems, thin clients, thick clients, laptop computer systems, tablet computer systems, cellular telephones (i.e., smart phones), multiprocessor systems, microprocessor-based systems, network PCs, minicomputer systems, mainframe computer systems, and distributed cloud computing environments that include any of the above systems or devices.

Computing device 400 includes communications fabric 402, which provides for to communications between one or more processing units 404, memory 406, persistent storage 408, communications unit 410, and one or more input/output (I/O) interfaces 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 416 and cache memory 418. In general, memory 406 can include any suitable volatile or non-volatile computer readable storage media. Software is stored in persistent storage 408 for execution and/or access by one or more of the respective processors 404 via one or more memories of memory 406.

Persistent storage 408 may include, for example, a plurality of magnetic hard disk drives. Alternatively, or in addition to magnetic hard disk drives, persistent storage 408 can include one or more solid state hard drives, semiconductor storage devices, read-only memories (ROM), erasable programmable read-only memories (EPROM), flash memories, or any other computer readable storage media that is capable of storing program instructions or digital information.

The media used by persistent storage 408 can also be removable. For example, a removable hard drive can be used for persistent storage 408. Other examples include optical and magnetic disks, thumb drives, and smart cards that are inserted into a drive for transfer onto another computer readable storage medium that is also part of persistent storage 408.

Communications unit 410 provides for communications with other computer systems or devices via a network. In this exemplary embodiment, communications unit 410 includes network adapters or interfaces such as a TCP/IP adapter cards, wireless Wi-Fi interface cards, or 3G or 4G wireless interface cards or other wired or wireless communications links. The network can comprise, for example, copper wires, optical fibers, wireless transmission, routers, firewalls, switches, gateway computers and/or edge servers. Software and data used to practice embodiments of the present disclosure can be downloaded to computing device 400 through communications unit 410 (i.e., via the Internet, a local area network, or other wide area network). From communications unit 410, the software and data can be loaded onto persistent storage 408.

One or more I/O interfaces 412 allow for input and output of data with other devices that may be connected to computing device 400. For example, I/O interface 412 can provide a connection to one or more external devices 420 such as a keyboard, computer mouse, touch screen, virtual keyboard, touch pad, pointing device, or other human interface devices. External devices 420 can also include portable computer readable storage media such as, for example, thumb drives, portable optical or magnetic disks, and memory cards. I/O interface 412 also connects to display 422.

Display 422 provides a mechanism to display data to a user and can be, for example, a computer monitor. Display 422 can also be an incorporated display and may function as a touch screen, such as a built-in display of a tablet computer.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

100 Sale creating/discovering environment
110 Network
120 Seller computing device
122 Buyer computing device
130 Web server
132 Sale discovery program
140 Route optimization engine
150 Database
200 Flowchart
202 Step
204 Step
206 Step
208 Step
210 Step
212 Step
300 Flowchart
302 Step
304 Step
306 Step
308 Step
310 Step
312 Step
314 Step
316 Step
318 Step
320 Step
322 Step
400 Computing device
402 Communications fabric
404 Processing units
406 Memory
408 Persistent storage
410 Communications unit
412 Input/output (I/O) interfaces
416 Random access memory (RAM)
418 Cache memory
420 External device(s)
422 Display

What is claimed is:

1. A method for discovering sales events, comprising:
receiving, by one or more computer processors, an event from a seller;
receiving, by the one or more computer processors, a first set of information from the seller;
storing, by the one or more computer processors, the first set of information in a database;
placing, by the one or more computer processors, a limit on the event;
receiving, by the one or more computer processors, an activation request from the seller; and,
activating, by the one or more computer processors, the event.

2. The method for discovering sales events as recited in claim 1, wherein the first set of information comprises at least one of an email address, a sale date, a sale date range, a sale time, a sale time range, a sale location, a sale goods genre, and a sale price range of the sale goods.

3. The method for discovering sales events as recited in claim 1, wherein the limit on the event is arranged to limit a duration of the event.

4. The method for discovering sales events as recited in claim 1, wherein the limit on the event is arranged to limit a frequency that the seller holds events.

5. The method for discovering sales events as recited in claim 1, wherein the limit on the event is arranged to limit a duration of the event and to limit a frequency that the seller holds events.

6. The method for discovering sales events as recited in claim 1, further comprising:
receiving, by the one or more computer processors, a request from a buyer;
receiving, by the one or more computer processors, a second set of information from the buyer;
generating, by the one or more computer processors, a list of one or more events based on the second set of information;
receiving, by the one or more computer processors, a selection from a buyer, wherein the selection includes at least one of the one or more events; and,
generating, by the one or more computer processors, an optimized route to each of the at least one of the one or more events.

7. The method for discovering sales events as recited in claim 6, wherein the second set of information comprises a filter including at least one of a postal code, a date, a date range, an origin location, a sale event genre, a tag, and an option to include a partner/advertiser advertisement campaign.

8. A computer program product for discovering sales events, comprising:
a computer readable storage medium and program instructions stored on the computer readable storage medium, the program instructions comprising:
program instructions to receive an event from a seller;
program instructions to receive a first set of information from the seller;
program instructions to store the first set of information in a database;
program instructions to place a limit on the event;
program instructions to receive an activation request from the seller; and,
program instructions to activate the event.

9. The computer program product for discovering sales events as recited in claim 8, wherein the first set of information comprises at least one of an email address, a sale date, a sale date range, a sale time, a sale time range, a sale location, a sale goods genre, and a sale price range of the sale goods.

10. The computer program product for discovering sales events as recited in claim 8, wherein the limit on the event is arranged to limit a duration of the event.

11. The computer program product for discovering sales events as recited in claim 8, wherein the limit on the event is arranged to limit a frequency that the seller holds events.

12. The computer program product for discovering sales events as recited in claim 8, wherein the limit on the event is arranged to limit a duration of the event and to limit a frequency that the seller holds events.

13. The computer program product for discovering sales events as recited in claim 8, further comprising:
program instructions to receive a request from a buyer;
program instructions to receive a second set of information from the buyer;
program instructions to generate a list of one or more events based on the second set of information;
program instructions to receive a selection from a buyer, wherein the selection includes at least one of the one or more events; and,
program instructions to generate an optimized route to each of the at least one of the one or more events.

14. The computer program product for discovering sales events as recited in claim 13, wherein the second set of information comprises a filter including at least one of a postal code, a date, a date range, an origin location, a sale event genre, a tag, and an option to include a partner/advertiser advertisement campaign.

15. A computer system for discovering sales events, comprising:
one or more computer processors;
one or more computer readable storage media; and,
program instructions stored on the computer readable storage media for execution by at least one of the one or more computer processors, the program instructions comprising:
program instructions to receive an event from a seller;
program instructions to receive a first set of information from the seller;
program instructions to store the first set of information in a database;
program instructions to place a limit on the event;
program instructions to receive an activation request from the seller; and,
program instructions to activate the event.

16. The computer system for discovering sales events as recited in claim 15, wherein the first set of information comprises at least one of an email address, a sale date, a sale date range, a sale time, a sale time range, a sale location, a sale goods genre, and a sale price range of the sale goods.

17. The computer system for discovering sales events as recited in claim 15, wherein the limit on the event is arranged to limit a duration of the event.

18. The computer system for discovering sales events as recited in claim 15, wherein the limit on the event is arranged to limit a frequency that the seller holds events.

19. The computer system for discovering sales events as recited in claim 15, wherein the limit on the event is arranged to limit a duration of the event and to limit a frequency that the seller holds events.

20. The computer system for discovering sales events as recited in claim 15, further comprising:
program instructions to receive a request from a buyer;
program instructions to receive a second set of information from the buyer;
program instructions to generate a list of one or more events based on the second set of information;
program instructions to receive a selection from a buyer, wherein the selection includes at least one of the one or more events; and,
program instructions to generate an optimized route to each of the at least one of the one or more events.
